(19) United States
(12) Patent Application Publication
(10) Pub. No.: US 2012/0268772 A1
(43) Pub. Date: Oct. 25, 2012

(54) SYSTEMS AND METHODS FOR VISUALLY PREVIEWING FINISHED PRINTED DOCUMENT OR PACKAGE

(75) Inventors: Robert John Rolleston, Rochester, NY (US); Neil Robert Sembower, Austin, TX (US)

(73) Assignee: XEROX CORPORATION, Norwalk, CT (US)

(21) Appl. No.: 13/092,300

(22) Filed: Apr. 22, 2011

(51) Int. Cl. G06F 15/00

(52) U.S. Cl. 358/1.15

(57) ABSTRACT

A thin client system and methods are disclosed for previewing a finished printed document or package in which a client computer system prompts a user to select from a predefined list of view positions and allows user selection or entry of view angles, a view position distance, and displayed page number and requests a single still image view of the produced document or package for review by the user.

### BACKGROUND AND INCORPORATION BY REFERENCE

The exemplary embodiments relate to apparatus and techniques allowing users to view a virtual representation of a printed job which incorporates user designated finishing options. Certain print jobs require advanced production equipment with an assortment of printing capabilities and finishing options (e.g., page imposition, folding, binding, etc.) to achieve the desired finished document or printed packaging for a user's product. On-site printers may not be able to provide the full functionality necessary to produce the finished document or package, and a user may instead send the print job to an outside facility. In other situations, a user may require a large number of printed documents, and printing such a job on-site may unduly burden an organization's printing equipment and/or prevent other users from using the printing equipment. Moreover, even if on-site printing equipment can complete a given print job, a user may decide to send the job off-site where an off-site printing vendor can do the job for a significantly lower price. Furthermore, it may be advantageous to have a given print job performed remotely in order to save shipping costs, for example where the printed documents or packaging are to be used in a city or country remote from the user's location.

Web-to-Print print job submissions allow a user to direct a print job to off-site production print facilities via the Internet, for instance, to send a high-volume print job to an external printing vendor with lower cost and/or better availability of printing and finishing options than are available in the user's enterprise or organization. Prior to sending a print job off-site, however, the user would prefer to have a high degree of confidence that the finished printed products, whether documents or printed packaging, will look as expected. The inability to provide such assurance has previously hindered widespread adoption of Web-to-print technology because it is difficult for users to verify that the document and job specifications have been properly defined. In the past, the user could review a listing of print job parameters, including formatting, print media type information, finishing options, etc., but such lists are often difficult to interpret and may be lengthy whereby the user is not confident in the conformance of the finished product with the user's desires.

Document visualization techniques have been proposed in which the user is provided with a two-dimensional view of the document, but when a user is creating a larger bound document, there are aspects of the finished printed product that are not readily visible in such a preview. Also, certain features of printed packages may not be easily verified using such a two-dimensional view. Advanced three-dimensional (3-D) previewing systems have been proposed in which the user is presented with a movable object view in a three-dimensional space. However, the controls associated with moving an object in a 3-D space are complex and difficult to understand for many users, and therefore this approach does not facilitate a user verifying whether the proposed print job will result in the desired finished document or package. Moreover, deployment of these adjustable 3-D previewing techniques requires significant client computer resources including the installation of special plug-ins or applications, and thus presents a barrier to widespread adoption, particularly in office enterprise situations.

Thus, while conventional previewing solutions provide some ability for a user to verify a finished printed product before job submission, these techniques do not provide tools to ensure sufficient user confidence for a large number of users, and improved techniques and systems are needed to facilitate more widespread adoption of Web-to-print production of printed documents and/or printed packaging.

U.S. Patent Application Pub. No. 2006/0114490, published Jun. 1, 2006, entitled SYSTEM AND METHOD FOR DOCUMENT PRODUCTION VISUALIZATION, to Rolleston, discloses a system and method for pre-print visualization of a job to be printed. The entirety of this printed publication is hereby incorporated by reference.

U.S. Pub. No. 2007/0268513, published Nov. 22, 2007, entitled METHOD AND SYSTEM FOR PRINT PRODUCTION CONFLICT VISUALIZATION, to Enloe, discloses a method for document print production conflict visualization and resolution. This publication is hereby incorporated by reference in its entirety. A document and a job ticket for printing are selected, with the job ticket including various document publishing requirements. Conflict analysis is performed to identify at least one conflict among the document publishing requirements and a visualization of each identified conflict is sequentially presented on a user interface. The visualizations utilize graphical clues, superimposed upon the rendering of a 3D model of the document, to clearly illustrate the nature of each problem, and sequentially show how each available suggested solution would resolve the conflict. The user interface requests approval to proceed with problem resolution if a conflict is identified among the publishing requirements or indicates that no conflict is present.

U.S. patent application Ser. No. 13/026,435, entitled METHOD AND SYSTEM FOR PROVIDING A THREE-DIMENSIONAL PREVIEW OF A FINISHED DOCUMENT, filed Feb. 14, 2011 to Dangler, et al. describes three-dimensional previewing a finished document based on a key feature analysis, in which the document is analyzed by a document analysis algorithm configured in association with a document visualization module in order to identify a number of key features associated with the document. A viewing script is created with respect to the key features, and a document-specific visual animation of the key features is displayed based on the viewing script at a user interface in order to preview the finished document. The entirety of this patent application is hereby incorporated by reference in its entirety.

U.S. Pat. No. 6,134,568 and U.S. Pat. No. 6,616,702, both to Tonkin, are directed to selecting components for assembly of a document, and previewing a simulation of an assembled document prior to physical assembly. The entireties of these patents are hereby incorporated by reference.

### BRIEF DESCRIPTION

The present disclosure presents systems and methods that provide an easily accessible three dimensional view of finished documents and/or packages prior to their production to facilitate soft-proofing allowing users to see critical final document elements including finishing options without requiring a hardcopy proof cycle, and without requiring the user to manipulate complex 3-D model view controls. A limited simplified set of 3-D visualization controls are presented to the user allowing selection of page number, viewing angle and distance including a list of two or more predefined view positions from which the user can select. All the 3-D transformations, moreover, are implemented on a network server so that the end-user client computer does not require burdensome application programs and/or plug-ins or specialized graphics rendering hardware. The disclosed concepts thus provide improved ease of use and mitigate the need for client-side software support beyond basic HTML support.

In accordance with one or more aspects of the present disclosure, a system is provided for still image preview of the finished printed document or package, including a server with a processor and a memory storing a 3-D model of the finished document/package defined by a print job file. The server is operative to receive one or more user parameters from a client system through a network connection, where the parameter identifies one or more of a view reference position, a view reference angle and/or a view reference distance. The system includes a rendering component operative to render a still image view of the 3-D model according to the parameter(s), and to store the still image view in an image buffer of the server memory. The server then transmits the still image view from the image buffer to the client system through the network connection. In certain embodiments, the server receives a print job file from the client system, and a 3-D model generation component is provided to create the 3-D model of the finished printed document or package according to the print job file, and to store the 3-D model in the memory. In certain embodiments, moreover, the 3-D model includes a visual representation of one or more finishing options specified by the print job file, and the rendering component renders the still image view including the visual representation of the finishing option(s). This can also be used to view any type of document or packaging feature which is dependent upon viewing and/or illumination angles, including without limitation Gloss, embossing, foils, stamps, etc.

Further aspects of the disclosure relate to a client system for providing a still image preview of a finished printed document or package. A client computer system is provided having a processor, a user interface with a display, and a network connection. A document production visualization prompting component is included, which presents a list of two or more predefined view positions to a user via the user interface. The visualization prompting component prompts the user to select one of the predefined view positions, and also prompts the user to select or enter one or more of a page number, a view position angle, and a view position distance. The prompting component creates a request including the selected view position and the selected or entered page number, viewing position angle and distance, and the client computer system transmits the request to a server through the network connection. The client computer system is operative to receive a still image view from the communications network in response to transmission of the request, and to display the still image view on the display.

In certain embodiments, the document production visualization prompting component is operative to prompt the user to select or enter a page number, and to provide a graphical indication showing a selected page among a plurality of pages of the document. The prompting component in certain embodiments is operative to prompt the user to select one of a top edge view position, a bottom edge view position, an oblique left view position, and an oblique right view position. In certain embodiments, the prompting component prompts the user to select or enter one or more of an up/down angle value, a left/right angle value, and/or a view distance value. In certain embodiments, the document production visualization component is operative to prompt the user to enter one or more of the up/down angle value, the left/right angle value, and the view distance value using a clickable display box allowing the user to enter a specific value or a slide control allowing the user to adjust the value.

Further aspects of the disclosure provide a method for previewing a finished printed document or package using a client computer system. The method includes sending a print job file defining a finished printed document or package from a client computer system to a server through a communications network, and presenting a list of two or more predefined view positions to a user via a user interface of the client computer system. The method further includes prompting the user to select one of the predefined view positions and to select or enter at least one of a page number, a view position angle, and a view position distance. The method further includes creating a request including the selected view position and at least one selected or entered page number, view position angle, and/or view position distance, and transmitting the request to the server through the communications network. Also, the method includes receiving a still image view from the server through the communications network in response to transmission of the request, and displaying the still image view on a display of the client computer system.

In certain embodiments, the method includes prompting the user to select one of a top edge view position, a bottom edge view position, an oblique left view position, and an oblique right view position. Certain embodiments, moreover, include prompting the user to select or enter at least one of an up/down angle value, a left/right angle value, and a view distance value. In some embodiments, the method includes prompting the user to enter at least one of the up/down angle value, the left/right angle value, and the view distance value using one or more clickable display boxes allowing the user to enter a specific value or using a slide control allowing the user to adjust the value.

### BRIEF DESCRIPTION OF THE DRAWINGS

The present subject matter may take form in various components and arrangements of components, and in various steps and arrangements of steps. The drawings are only for purposes of illustrating preferred embodiments and are not to be construed as limiting the subject matter.

FIG. 1 is a schematic view of an exemplary environment in which a thin client pre-print 3-D job visualization system and a server-based rendering system operate to provide a still image preview of a finished printed document or package to a user in accordance with one or more aspects of the exemplary embodiment;

FIG. 2 is a front elevation view illustrating a client computer graphical user interface display showing a document production visualization and associated controls in accordance with the present disclosure; and

FIG. 3 is a flow diagram illustrating an exemplary method for providing a still image preview of a finished printed document or package according to the disclosure.

### DETAILED DESCRIPTION

Several embodiments or implementations of the different aspects of the present disclosure are hereinafter described in conjunction with the drawings, wherein like reference numerals are used to refer to like elements throughout, and wherein the various features, structures, and graphical renderings are not necessarily drawn to scale. The disclosure relates to systems and methods for 3-D document previewing in which a thin client computer system is provided with simple controls for requesting a 3-D still image page view, without requiring client-side installation of complicated application programs and/or plug-ins and/or hardware. The client system can be implemented using a simple web browser, where the server implements complex 3-D modeling of a produced document or product package in response to a user directed request from the client system with a simple still image of the document viewed in the selected state. The disclosed techniques provide an alternative to fully interactive 3-D document production visualization, and do not require the user to understand operation of complex 3-D model manipulation controls. Moreover, the proposed systems and methods do not expend client-side computing resources for 3-D modeling or manipulation. Thus, the disclosed concepts solve the problem of users having to understand complex manipulation and navigation of objects in a 3-D space, and mitigate or avoid the need for any special client-side software and/or hardware. Moreover, the disclosure presents the user with the ability to view a perspective finished product document or package from multiple view positions to facilitate user confidence in the finished product before authorizing production.

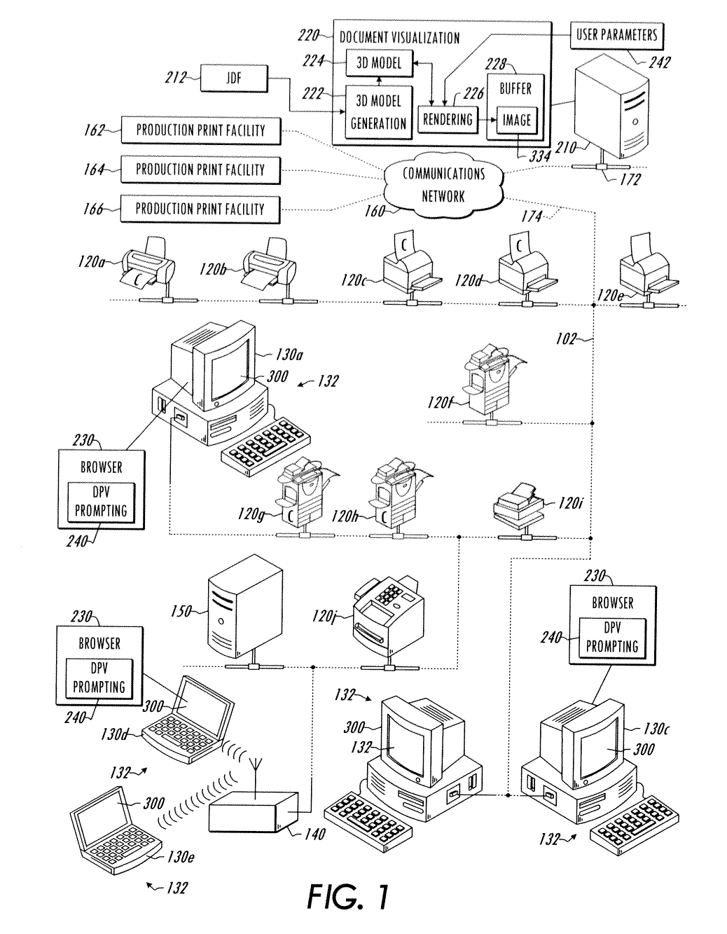

FIG. 1 shows an exemplary distributed computing environment including one or more client computing devices 130. In the illustrated environment, the client computers 130 are selectively authorized to print or initiate other document processing operations via enterprise printing devices 120 and can also submit print jobs to an external production print facilities 162, 164 and 166 through a communications network 160. The illustrated customer computers 130 and device 120 are operatively coupled with one another via a customer network 102 which may be any suitable form of communications network or interoperative networks. The network 102, moreover, includes a network interface 174 for operative connection of the devices 120 and the client computers 130 with the communications network 160. In addition, one or more print servers 150 are coupled with the network 102, where certain portions of the network 102 may be interconnected by cabling or one or more portions may be wireless, and where one or more exemplary computers 130d and 130e are illustrated in FIG. 1 with operative communicative coupling to the network 102 implemented using a wireless network transceiver interface component 140. Any number of user (client) computers 130 may be operatively coupled to the network 102, including without limitation desktop computers 130a and 130b, laptop computers 130d and 130e, and any number of document processing devices 120 may be coupled with the network 102.

Different forms of local document processing devices 120 are networked together in this example to provide the client computers 130 with a broad range of document processing options available for a given print job or other task. The exemplary document processing devices 120 shown in FIG. 1 include relatively low throughput externally fed color as well as black and white desktop printers 120a and 120b, respectively, intermediate speed drawer fed color and black and white printers 120c-120e, high volume color as well as black and white printer/scanner/copier (i.e., multi-function) devices 120f-120h, a desktop combination printer/scanner/copier 120i and a combination printer and facsimile machine 120j. Document processing devices 120 may include any device operable to perform one or more document processing functions, including without limitation printers, scanners, copiers, combination scanner-printer-copier machines, and the like.

The customer network 102 and the external network 160 can be arranged in any suitable configurations, for example, star, ring, bus, tree, mesh, etc. or combinations thereof, and may be wired networks, wireless networks, or combinations thereof, wherein the illustrated customer network 102 of FIG. 1 provides one or more wireless nodes 140 for connectivity for portable laptop client computers 130d and 130e through various WiFi or other wireless means.

One or more of the client computers 130 are configured to run a browser 230, and also include thin client document production visualization (DPV) prompting components 240 for obtaining user input as described further hereinafter. The prompting components 240 in certain embodiments are implemented in hardware, processor-executed software, logic or combinations thereof in the client system 130, and may be wholly or partially implemented in conjunction with a browser 240 running on the client computer 130.

The second communications network 160 can be the Internet or other suitable network by which multiple devices connected thereto can communicate with one another. As shown in FIG. 1, one or more external print production facilities 162, 164 and 166 are operatively coupled to the communications network 160. A document production visualization (DPV) server 210 is also operatively coupled with the network 160 via a network connection 172. Thus configured, one or more of the client computer systems 130 can exchange messages with the DPV server 210 and with the remote printing facilities 162, 164 and/or 166 via the networks 102, 160 and the associated network connections.

The DPV server 210 implements a system for providing a still image preview of a finished print a document or package in accordance with various aspects of the present disclosure, and includes a processor and memory (not shown) for storing data and for executing program instructions. In particular, the server 210 implements a document visualization system 220 as described further below in hardware, processor-executed software, logic, or combinations thereof.

In operation, a user of a client computer system 130 may prepare a document using a word processor or other application program, and submit this as a print job file 212 to one of the local printers 120, or may send such a print job as a print job file 212 (a Job Definition Format file or JDF in one example) to one of the external production print facilities 162, 164, 166. In this case, the user may send the print job file 212 directly to the production print facility 162, 164, 166, or the print job file 212 may be initially submitted from the client computer 132 the DPV server 210, which thereafter sends the print job file 212 to the production print facility 162, 164, 166. Alternatively, the user may submit a print job file 212 from the client computer 132 one or more of the production print facilities 162, 164, 166, with the production print facility thereafter sending the print job file 212 to the DPV server 210. As noted above, the user may desire to utilize an off-site production print facility 162, 164, 166 for a variety of reasons, including without limitation cost savings, limited local printing capabilities, reduction in shipping costs, etc.

The “print job file” 212 as used herein, includes a document to be printed, which may include one or more related sheets or electronic document page images, and/or the print job file 212 and represent printing of a package or other structural document, wherein “pages” or “page numbers”, as used herein include states or positions of such packaging or structural document, including without limitation open, closed, ajar, etc., as well as a print job ticket comprising information on how the job is to be printed (e.g., page size, paper type, printer, and finishing requirements). Each page image generally may include information in electronic form which is to be rendered on the print media by the printer and may include text, graphics, pictures, and the like. A “finisher” can be any post-printing accessory device of a printing system, such as a collator, sorter, mailbox, inserter, interposer, folder, stapler, stacker, hole puncher, stitcher, binder, envelope stuffer, postage machine, or the like, wherein finishing options include any selective operation of such finishing devices as may be designated or desired by a user, with such finishing options being specified by the print job file 212 or a job ticket portion thereof. The operation of applying images to print media, for example, graphics, text, photographs, etc., to printable sheet media, packages, or other structures is generally referred to herein as printing.

The DPV server 210 implements the document visualization system 220 in any suitable fashion, such as by execution of one or more computer executable instructions stored in memory of the server 210, or by operation of any suitable hardware, configurable logic, processor executed software, or combinations thereof. In one possible implementation, the document visualization system 220 includes a rendering component 226 with access to an internal or externally stored 3-D model 224 that represents a finished printed document or package defined by the print job file 212. The rendering component 226 is operative to render a still image view 334 of the 3-D model 224 according to one or more parameters 242, and to store the still image view 334 in an image buffer 228. In operation, the server 210 receives one or more user parameters 242 from a submitting client system 130 (e.g., directly, or forwarded by a production print facility 162, 164, 166 to which the client computer 130 submitted the print job file 212). The received parameter or parameters 242 identify at least one aspect of a desired still image view, such as a view reference position a selected page (including structural document or product position, configuration or other state thereof), a view reference angle, and/or a view reference distance.

As noted above, users often send print jobs to a production print facility 162, 164, 166 for production of a large quantity of finished sheet or structural documents and/or printed products. Since a large quantity of the finished documents may be produced in a single production run, it is important that the resulting printed materials be produced as expected by the user placing the order. Accordingly, the DPV server 210 and the client system 130 provide document visualization to ensure that the document content, the method of binding/finishing, and any ancillary services such as cutting, folding, inserting tabs, etc. are all correctly defined for the prospective print job. As previously discussed, many users do not know how to examine textual content of a job ticket, due to complexity and details of the data, and therefore merely providing access to job ticket details typically will not give the user a sufficient level of confidence to encourage use of remote printing facilities 162, 164, 166. Moreover, the currently available or proposed systems that provide manipulatable 3-D models require complex, resource consuming application programs and/or plug-ins (e.g., Flash, Java, Java3D, etc.) on the client computer system, and also require the user to know how to use complex 3-D manipulation tools and controls.

The presently disclosed system, on the other hand, provides the user with a set of predefined view positions from which to choose, and the ability to select or enter a limited set of view parameters, whereby the client-side computer system 130 need not have complex dedicated software for three-dimensional previewing. Instead, the exemplary embodiments can operate the client system 130 through a conventional browser 230 to implement the DPV prompting 240.

In the embodiments of FIG. 1, the user of the client system 130 can submit a print job file 212 directly to the DPV server 210, or the file 212 can be first sent to one or more preproduction print facilities 162, 164, 166, which then forward the print job file 212 to the server 210 to facilitate user previewing. In some embodiments, the server-side document visualization system 220 includes one or more default parameters, such as a default page number and view position (e.g., page 1, viewed from the front at a slight angle and a predetermined view position distance from the document). The server 210 may use the received print job file 212 to construct a 3-D model 224 using a 3-D model generation component 222 of the document visualization system 220. The rendering component 226 uses the default parameters to render a single still image view 334 of the 3-D model 224, which is then stored in an image buffer 228. The server 210 sends this default still image view 334 through the communications network 160 to the client computer system 130 via the network interface 174 and the local network 102. The image 334 is displayed by the client browser 230 and a user interface display 300 of the client system 130.

The client system 130 implements a DPV prompting component 240 via the user interface 132 in order to prompt the user (with or without a displayed default view image 334), where the user prompting can be by any suitable human interaction means, including without limitation visual prompting using a display 300 of the client system 130, audible prompting using audible sounds emitted by the system 130, etc. In addition, any form of user interaction can be used to provide user input in the form of selections and/or value entries, including without limitation mouse or other pointing device interaction with displayed actuators, touch screens, keyboards, voice recognition or other audible inputs received by the system 130 from a user, etc.

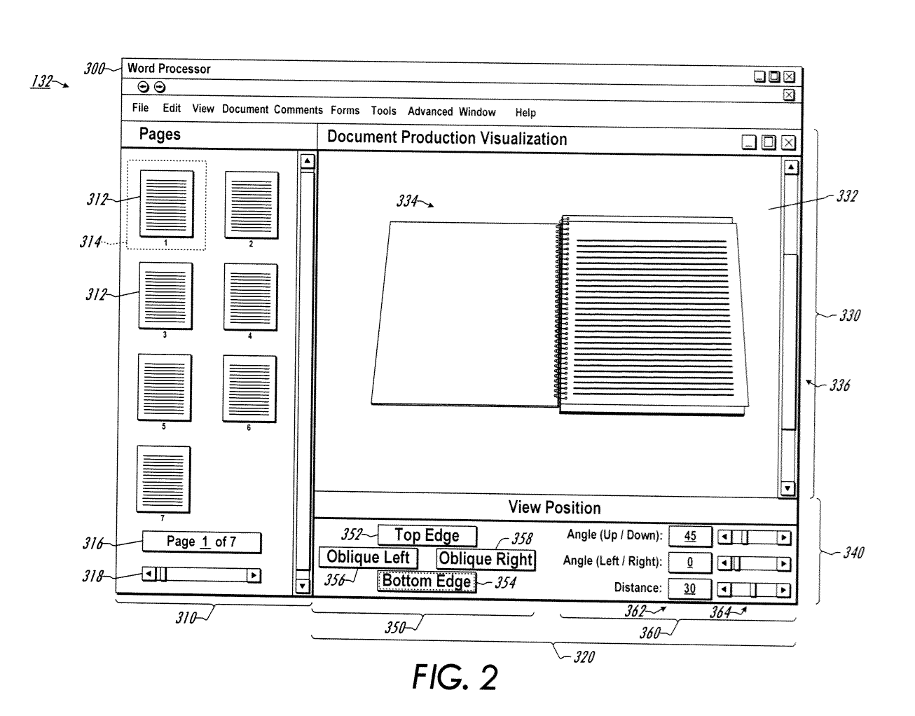

FIG. 2 illustrates a graphical user interface 132 with a display 300 showing exemplary document production visualization prompting and associated controls in a client computer system 130. This prompting includes a screen portion 310 showing several pages of a submitted document (pages 1-7 in this example) with each page being shown as a small reproduction or representative graphic 312. In addition, the user is able to select a particular page reproduction 312 for use in the 3-D visualization by one or more means, including without limitation the ability to actuate one of the reproductions 312 (e.g., by clicking on the selected reproduction 312 with a mouse, actuating a particular reproduction 312 physically using a touch screen display 300, or moving a selection indicator 314 left, right, up and/or down via keyboard of the client system 130, etc.). This gives the user the ability to select a particular page of the submitted document for which a still image 3-D visualization view 334 is rendered on the display 300. In addition, the illustrated embodiment provides an entry box 316 into which a user can type the desired page number, and/or a slide control 318 is provided in the display portion 310 which allows the user to slide and drag an indicator that changes the page selection and/or to click end arrow buttons of the control 318 to increment or decrement a currently indicated page number.

As noted above, the document production visualization prompting component 240 of the client systems 130 allows previewing of normal printed documents as well as printed product packaging or other structural documents. In this regard, the page selection concepts herein apply as well to packaging jobs and structural document jobs, for instance, wherein the ability to select a page number by the various tools in the area 310 can be adapted to select a given product or structural document configuration or state, wherein all such variant implementations are contemplated as being “page selections” as used herein. For example, certain embodiments can determine that a given submitted print job is for a structural document or a product package, wherein the clickable selection, the value entries selection tool 316, and/or the slide selection control 318 can be used to change a product or structural document position, orientation, or configuration, such as selecting between “closed”, “ajar”, “open”, etc.

The exemplary display 300 also includes a visualization portion 320 including a rendering portion 330 having a display area 332 in which the still image view 334 is displayed, and which may also include one or more scroll or position controllers 336 by which a user can move the still image view 334 up, down, and/or side to side. The visualization portion 320 also includes a user prompting area 340, in this case situated below the rendering portion 330. In the prompting area 340, the DPV prompting component 240 of the client system 130 presents a list 350 of two or more predefined positions to the user via the interface 132. In the illustrated example, the predefined positions include clickable actuators (display buttons actuatable by mouse action, voice command, touch screen actuation, etc.) by which the user can select a top edge view 352, a bottom edge view 354, an oblique left view 356, or an oblique right view 358. The example shown in the figure is for a selected bottom edge view 354, where the exemplary display prompting includes indicia by which the user can tell what is currently selected in the list 350.

In the illustrated embodiment, moreover, further parameter entries are possible in an angle/distance entry portion 360 of the display 350, in which current values are displayed numerically for an up/down angle, a left/right angle, and a distance. In this example, the current values are displayed in corresponding boxes 362 into which a user can click and then enter a desired value (e.g., using a mouse, keyboard, voice activation, etc.) to enter a desired value. These values, moreover, can be adjusted in certain examples by way of drop-down lists or other sets of predetermined values. In one example, the angle values may only allow selection of integers, and may be further restricted to only provide increments of a fixed number of degrees (e.g., 0°, 15°, 30°, 45°, etc.), or other predetermined sets of values can be listed which need not be equally spaced. Similarly, the view distance value sets the spacing from the view position to the document in the selected direction, and may allow user entry of only integer values, and the available values may be restricted in certain embodiments (e.g., 0 inches, 3 inches, 6 inches, etc.). The illustrated prompting, moreover, includes slide controls 364 operable by either user selection and dragging of a slide indicia and/or clicking of end buttons to increment or decrement the corresponding angle or distance value.

The exemplary client system 130 of FIG. 1 in certain embodiments implements the document production visualization prompting component 240 by way of a browser 230 to thereby present the list 350 of predefined view positions 352, 354, 356 and 358 to the user via the user interface 132, and to prompt the user to select one of the predefined view positions. In addition, the prompting component 240 prompts the user to select or enter at least one of a page number, a view position angle, and a view position distance, where the prompting for page number can provide prompting for closed, ajar, open, etc. positioning or orientation of a finished printed package or structural document according to the type of document to be produced for a given print job filed 212. Once the user enters the selections, the prompting component 240 creates a request (e.g., a message or series of messages in certain embodiments) which includes the selected predefined view position (352, 354, 356 or 358) as well as one or more selected or entered values for the displayed page number, view position angle and/or view position distance.

The client computer system 130 then transmits the assembled request to the server 210 through the communications network 160. The DPV server 210 receives the request including the user designated parameters 242 from the client system 130 through the network connection 172, and renders a still image view 334 using the rendering component 226, which is then stored in the image buffer 228 of the document visualization system 220. The server 210 then transmits the still image view 334 from the image buffer 228 to the client system 130 through the network connection 172 via the communications network 160. The client system 130 then receives the still image view 334 from the network 160 in response to its transmission of the request, and displays the still image view 334 on the display 300 as shown in FIG. 2. In this regard, the 3-D model generation component 222 of the server 210 in certain embodiments is configured to create the 3-D model 224 including a visual representation of one or more finishing options (e.g., binding) specified by the print job file 212, and the rendering component 226 is operative to render the still image view 334 including the visual representation of the finishing options designated by the user. Thus, the displayed still image view 334 incorporates enough visual information for a user to ascertain the correctness of the submitted print job file 212, and the user is provided with simple controls for visually verifying the job without having to support excess software on the client side computer system 130 and without having to manipulate complex three-dimensional models on the client 130. This process can be iterated any number of times till the user is satisfied that they have viewed the document in the desired state, after which the client system 130 can send a confirmation or verification to the server 210 and/or directly to the production print facility 162, 164, 166 indicating that production of the print job should begin.

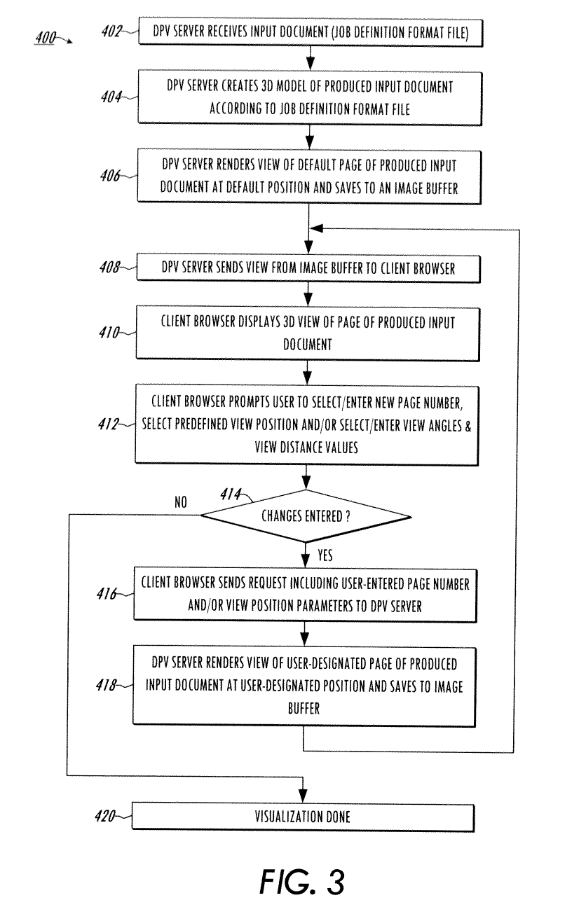

FIG. 3 illustrates an exemplary method 400 for providing a still image preview of a finished printed document or package according to one or more aspects of the disclosure. The method 400 may be implemented in a computer program product that may be executed on a computer, such as a non-transitory tangible computer-readable recording medium on which a control program is recorded, such as a disk, hard drive, or the like. Common forms of tangible computer-readable media include without limitation floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other medium from which a computer can read and use. The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, or PAL, or the like. In general, any device, capable of implementing a finite state machine that is in turn capable of implementing the flow diagram shown in FIG. 3, can be used to implement the method for interactive selection of finishing options.

Beginning at 402, the method 400 includes the DPV server (210) receiving an input document, such as a Job Definition Format (JDF) or other form of print job file 212, and creating a 3-D model of a produced document (including sheet documents, structural documents, products, etc.) at 404 according to the JDF. At 406, the DPV server 210 renders a view 334 of a default page of the produced input document at default positions and saves the still image view 334 to an image buffer. At 408, the DPV server 210 sends the view 334 from the image buffer 228 to the browser 230 of the client system 130. At 410, the client browser 230 displays the 3-D view of the default page of the produced input document. At 412, the client browser 230 prompts the user to select a viewed page number (or product/structural document opened, closed, ajar, etc., value). Also at 412, the browser 230 prompts the user to select one of a set of predefined view positions (e.g., top edge, bottom edge, oblique left, oblique right in the above example), and the user is prompted to select or enter one or more view angles and view distance values. A determination is made at 414 as to whether the user entered any changes relative to the optionally displayed default view. If not (NO at 414), the process 400 proceeds to 420 where the visualization is done. If the user enters one or more parameters or values (YES at 414) the browser 230 sends a request at 416 to the server 210, which includes the user entered page number and/or view position parameters 242. At 418, the DPV server 210 renders the still image view 334 of the user-designated page of the produced input document and any user-designated position angles and distances, and saves the image view 334 to the image buffer 228. The process then returns to 408 as described above, at which the DPV server 210 sends the view 334 from the image buffer 228 to the client browser 230 to be displayed to the user. The process can then be repeated at 408 through 418 any number of times to provide the user with 3-D still images by which the correctness of the print job file 212 can be ascertained with a high degree of confidence.

The above examples are merely illustrative of several possible embodiments of the present disclosure, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, processor-executed software, or combinations thereof, which performs the specified function of the described component (i.e., that is functionally equivalent), even though not structurally equivalent to the disclosed structure which performs the function in the illustrated implementations of the disclosure. In addition, although a particular feature of the disclosure may have been disclosed with respect to only one of several embodiments, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”. It will be appreciated that various of the above-disclosed and other features and functions, or alternatives thereof, may be desirably combined into many other different systems or applications, and further that various presently unforeseen or unanticipated alternatives, modifications, variations or improvements therein may be subsequently made by those skilled in the art which are also intended to be encompassed by the following claims.

The following is claimed:

1. A system for providing a still image preview of a finished printed document or package, comprising:
a server, comprising:
a processor,
a memory storing a 3-D model of a finished printed document or package defined by a print job file, and including an image buffer, and
a network connection operatively coupled with a communications network,
the server being operative to receive at least one user parameter from a client system through the network connection, the at least one user parameter identifying at least one of a view reference position, a view reference angle, and a view reference distance; and
a rendering component operative to render a still image view of the 3-D model according to the at least one user parameter, and to store the still image view in the image buffer;
the server being operative to transmit the still image view from the image buffer to the client system through the network connection.

2. The system of claim 1, wherein the server is operative to receive a print job file from the client system through the network connection, the system further comprising a 3-D model generation component operative to create the 3-D model of the finished printed document or package according to the print job file, and to store the 3-D model in the memory.

3. The system of claim 2, wherein the 3-D model generation component is operative to create the 3-D model including a visual representation of at least one finishing option specified by the print job file, and wherein the rendering component is operative to render the still image view including the visual representation of the at least one finishing option.

4. The system of claim 1, wherein the 3-D model includes a visual representation of at least one finishing option specified by the print job file, and wherein the rendering component is operative to render the still image view including the visual representation of the at least one finishing option.

5. A client system for providing a still image preview of a finished printed document or package, comprising:
a client computer system, comprising:
a processor,
a user interface including a display, and
a network connection operatively coupled with the communications network; and
a document production visualization prompting component operative to:
present a list of two or more predefined view positions to a user via the user interface,
prompt the user to select one of the predefined view positions, and to prompt the user to select or enter at least one of a page number, a view position angle, and a view position distance, and
create a request including the selected one of the predefined view positions, and the at least one selected or entered page number, view position angle, and view position distance;
the client computer system being operative to:
transmit the request to a server coupled with a communications network through the network connection,
receive a still image view from the communications network through the network connection in response to transmission of the request, and
display the still image view on the display.

6. The client system of claim 5, wherein the document production visualization prompting component is operative to prompt the user to select or enter a page number and to provide a graphical indication showing a selected page among a plurality of pages of the document.

7. The client system of claim 6, wherein the document production visualization prompting component is operative to prompt the user to select one of a top edge view position, a bottom edge view position, an oblique left view position, and an oblique right view position.

8. The client system of claim 7, wherein the document production visualization prompting component is operative to prompt the user to select or enter at least one of an up/down angle value, a left/right angle value, and a view distance value.

9. The client system of claim 8, wherein the document production visualization prompting component is operative to prompt the user to enter at least one of the up/down angle value, the left/right angle value, and the view distance value using at least one of a clickable display box allowing the user to enter a specific value or a slide control allowing the user to adjust the value.

10. The client system of claim 6, wherein the document production visualization prompting component is operative to prompt the user to select or enter at least one of an up/down angle value, a left/right angle value, and a view distance value.

11. The client system of claim 10, wherein the document production visualization prompting component is operative to prompt the user to enter at least one of the up/down angle value, the left/right angle value, and the view distance value using at least one of a clickable display box allowing the user to enter a specific value or a slide control allowing the user to adjust the value.

12. The client system of claim 5, wherein the document production visualization prompting component is operative to prompt the user to select one of a top edge view position, a bottom edge view position, an oblique left view position, and an oblique right view position.

13. The client system of claim 12, wherein the document production visualization prompting component is operative to prompt the user to select or enter at least one of an up/down angle value, a left/right angle value, and a view distance value.

14. The client system of claim 13, wherein the document production visualization prompting component is operative to prompt the user to enter at least one of the up/down angle value, the left/right angle value, and the view distance value using at least one of a clickable display box allowing the user to enter a specific value or a slide control allowing the user to adjust the value.

15. The client system of claim 5, wherein the document production visualization prompting component is operative to prompt the user to select or enter at least one of an up/down angle value, a left/right angle value, and a view distance value.

16. The client system of claim 15, wherein the document production visualization prompting component is operative to prompt the user to enter at least one of the up/down angle value, the left/right angle value, and the view distance value using at least one of a clickable display box allowing the user to enter a specific value or a slide control allowing the user to adjust the value.

17. A method for previewing a finished printed document or package using a client computer system, the method comprising:
sending a print job file defining a finished printed document or package from a client computer system to a server through a communications network;
presenting a list of two or more predefined view positions to a user via a user interface of the client computer system;
prompting the user to select one of the predefined view positions;
prompting the user to select or enter at least one of a page number, a view position angle, and a view position distance;
creating a request including the selected one of the predefined view positions, and the at least one selected or entered page number, view position angle, and view position distance;
transmitting the request to the server through the communications network;
receiving a still image view from the server through the communications network in response to transmission of the request; and
displaying the still image view on a display of the client computer system.

18. The method of claim 17, comprising prompting the user to select one of a top edge view position, a bottom edge view position, an oblique left view position, and an oblique right view position.

19. The method of claim 17, comprising prompting the user to select or enter at least one of an up/down angle value, a left/right angle value, and a view distance value.

20. The method of claim 17, comprising prompting the user to enter at least one of the up/down angle value, the left/right angle value, and the view distance value using at least one of a clickable display box allowing the user to enter a specific value or a slide control allowing the user to adjust the value.
